(19) United States
(12) Patent Application Publication
(10) Pub. No.: US 2014/0183993 A1
(43) Pub. Date: Jul. 3, 2014

(54) STATOR OF ROTARY ELECTRIC MACHINE

(71) Applicant: Akira Takasaki, Toyota-shi (JP)

(72) Inventor: Akira Takasaki, Toyota-shi (JP)

(21) Appl. No.: 13/823,542

(22) PCT Filed: Sep. 22, 2011
(86) PCT No.: PCT/JP2011/071650

§ 371 Date: Mar. 14, 2013

(51) Int. Cl. H02K 3/50

(52) U.S. Cl. CPC H02K 3/50
USPC 310/71

(57) ABSTRACT

An extended end portion (20) of a coil conducting wire (16) and an extended end portion (30) of a flat plate bus bar (35) are placed in parallel and adjacent to each other. The width of the bus bar (36) is wider than that of the coil conducting wire (16). On an end portion of the bus bar extended end portion (30), a tapered portion (44) is formed. Tip ends of the coil conducting wire extended end portion (20) and of the bus bar extended end portion (30) are welded to each other. As the tip end of the bus bar extended end portion is thin, welding heat is transmitted to a deeper position in the longitudinal direction of the bus bar, which results in a wider welding area. In addition, welded material flows along the slant surface of the tapered portion (44), which also results in a wider welding area.

### TECHNICAL FIELD

The present invention relates to a stator of a rotary electric machine, and in particularly to a structure of a part thereof related to connection of a coil conducting wire.

### BACKGROUND ART

Motors for converting electric energy into kinetic rotation energy, generators for converting kinetic rotation energy into electric energy, and electric devices for functioning as both a motor and a generator have been known. In the following, these electric machines are referred to as a rotary electric machine.

A rotary electric machine has two coaxial members for relative rotation. In general, one of the two members is fixed, while the other is free to rotate. A coil is provided to the fixed member (stator), and electricity is supplied to the coil to generate a rotating magnetic field. With relative action with the magnetic field, the other member (rotor) rotates. The coil mounted on the stator is formed by, e.g., mounting a coil conducting wire that is formed into a predetermined shape on a stator and then connecting the coil conductive wires to each other.

Patent Document 1 mentioned below describes a technique for placing side by side and welding a flat plate bus bar and an enameled wire constituting a coil side.

### RELATED ART DOCUMENT

### Patent Document

Patent Document 1: JP2008-193767A

### Problem to be Solved by the Invention

In placing side by side and welding an end portion of a flat plate bus bar and an end portion of a coil conducting wire, the welding area may be resulted smaller or one-sided due to displacement between the end surfaces. This may reduce the strength of the welded portion.

The present invention aims to ensure sufficient welding strength in welding end surfaces.

### DISCLOSURE OF INVENTION

### Means to Solve the Problem

The stator of a rotary electric machine according to the present invention includes a plurality of coil conducting wires mounted on a stator core and at least one bus bar that is made using a flat plate member wider than the coil conducting wire and connected to at least one coil conducting wire. The plurality of coil conducting wires are connected to each other either directly or via a bus bar or through a combination of direct connection and connection is a bus bar to thereby constitute a stator coil. A bus bar may connect neutral points of the stator coils for three phases and also connect a stator coil and a power line for supplying power to the stator coil.

The coil conducting wire and the bus bar are connected to each other by means of welding. The coil conducting wire has a coil conducting wire extended end portion formed at at least one and portion thereof. The bus bar has a bus bar extended end portion formed at at least one end portion thereof. These coil conducting wire extended end portion and bus bar extended end portion are extending in parallel, and their end portions are welded to each other. The coil conducting wire extended end portion is placed adjacent to a wider lateral surface of the bus bar that is made using a flat plate member. The tip end of the bus bar extended end portion is tapered in the width direction.

The width of the tip end of the bus bar extended end portion can be made larger than that of the tip end of the coil conducting wire. Further, a cross section of the coil conducting wire can be rectangular, and the longer side of the rectangle can be opposed to the bus bar.

A bus bar having bus bar extended end portions formed at two respective end portions thereof may be welded to coil conducting wires at these two end portions, whereby these coil conducting wires are connected to each other. Meanwhile, a bus bar having a bus bar extended end portion formed only at one end portion thereof may be welded to a coil conducting wire at the one end portion that is tapered, and connected to a power line at the other end portion thereof. With the above, the coil conducting wire and the power line are connected to each other. Further, an end portion of the bus bar where a power line is connected may be formed tapered and welded to the power line, similar to welding to a coil conducting wire.

A bus bar having two tapered end portions can be used as a phase coil bus bar for connecting coil conducting wires for each phase of a rotary electric machine to thereby form a stator coil. A bus bar having two tapered end portions can also be used as a neutral point bus bar for connecting one end of stator coils for the respective phases to thereby form a neutral point. When such a bus bar is used as a neutral point bus bar, a branched portion may be formed between the respective end portions, and a bus bar extended end portion may also be formed at the end portion of the branched portion, so that one end portion of each of the three phase stator coils can be welded to the three respective end portions

Phase coil bus bars for the respective phases, including at least one for each phase, can be integrated through molding using insulating material, such as resin or the like, to thereby form a bus bar module. The bus bar module may be formed through molding so as to include a neutral point bus bar. Further, the bus bar module may be formed through molding so as to include a bus bar that is connected to a power line at one end portion thereof, that is, a power line bus bar. An end portion of the power line bus bar to which a coil conducting wire is connected is tapered. The bus bar module may be placed adjacent to a stator coil in the rotation axial direction of the rotary electric machine. Then, the coil conducting wire extended end portion and a bus bar extended end portion are placed extending in the rotation axial direction of the rotary electric machine in a direction departing from the stator core.

### Advantage of the Invention

With the tapered shape formed, welding heat is transmitted from a tip end to a deeper position, which results in a wider welding area. Further, welded material flows along the tapered shape, which also results in a wider welding area.

### BRIEF DESCRIPTION OF DRAWINGS

FIG. 1 is a perspective view of a stator of a rotary electric machine;

FIG. 2 shows a bus bar module mounted on a stator;

FIG. 3 is a perspective view of a bus bar module alone;

FIG. 4 is a cross sectional view of a bus bar module along the line A-A shown in FIG. 3;

FIG. 5 explains a section 38 where a bus bar is accommodated;

FIG. 6 shows a shape and disposition of a bus bar in a bus bar module;

FIG. 7 is a perspective view showing detailed shapes of a bus bar extended end portion and a coil conducting wire extended end portion;

FIG. 8 snows a detailed shape of a bus bar extended end portion;

FIG. 9 shows a condition of welding when a bus bar without a tapered tip end is used;

FIG. 10 shows a condition of welding when a bus bar with a tapered tip end is used;

FIG. 11 is a cross sectional view showing a condition of welding along a direction perpendicular to the longitudinal direction of a bus bar; and

FIG. 12 explains a condition of welding in which a coil conducting wire is positioned displaced relative to a bus bar.

### BEST MODE FOR CARRYING OUT THE INVENTION

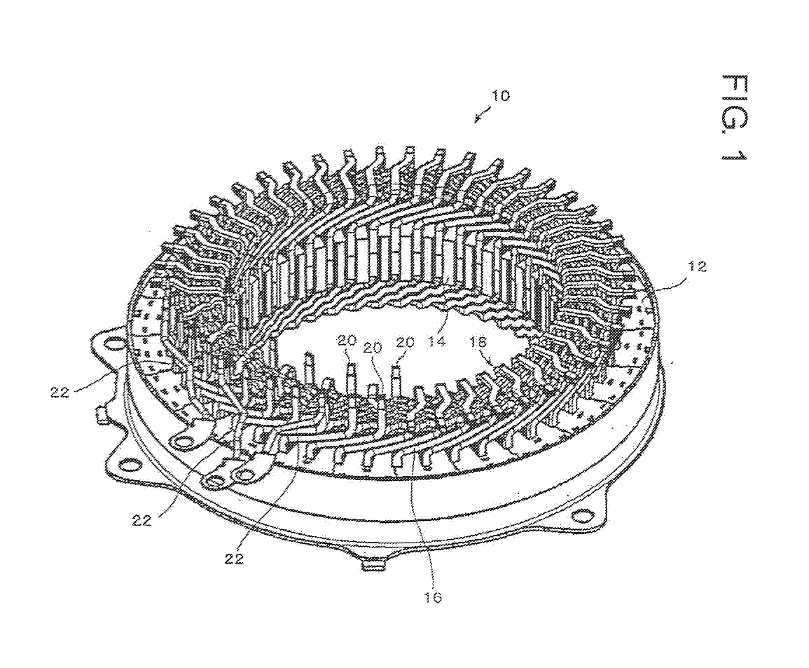

In the following, an embodiment of the present invention will be described, referring to the accompanying drawings. FIG. 1 is a perspective view showing external appearance of the stator 10 of a rotary electric machine, with a bus bar module, to be described later, omitted. The stator 10 has a stator core 12 having a substantially annular or cylindrical shape in which teeth 14, constituting a magnetic pole, are placed in the circumferential direction on the inner surface of the stator core 12. A coil conducting wire 16 is wound around the teeth 14, whereby a stator coil 18 is mounted on the stator core. In this embodiment, a plurality of coil conducting wires 16 that are formed into a predetermined shape are inserted into the respective spaces between the teeth 14, that is, slots, and welded to each other or connected to each other via a conductor, such as a bus bar or the like, whereby the stator coil 18 is formed. More specifically, the coil conducting wires 16 are welded and thereby directly connected to each other, whereby a partial coil, that is a part of the stator coil 18, is formed. Then, respective ends of the coil conducting wires 16 of the partial coils are connected to each other by a conductor, such as a bus bar, or the like, other than a coil conducting wire, whereby the stator coil 18 is formed.

The stator 10 has an annular or cylindrical shape even when the stator coil 18 is mounted on the stator core 12 having an annular or cylindrical shape. In the following, regarding the shape of the stator or the like, an annular or cylindrical shape will be simply referred to as an annular shape. A rotor (not shown) is disposed inside the stator 10 having an annular shape. Supplying power to the stator coil 18 generates a rotating magnetic field in the space inside the annular shape of the stator 10, and the rotator rotates through mutual reaction with the magnetic field. The axis of rotation of the rotor is the rotation axis of the rotary electric machine, being coincident with the central axis of the annular shape of the stator 10. Note that the direction in which the rotation axis of the rotary electric machine, that is the central axis of the annular shape of the stator 10, extends will be referred to as a rotation axial direction in the following description.

As shown in FIG. 1, an end of a coil conducting wire projects upward, that is, in the rotation axial direction, from the stator coil 18 in FIG. 1. The end portion of the coil conducting wire extending from the stator coil 18 is referred to as a coil conducting wire extended end portion 20. In the case of the stator 10, two pairs of partial coils are provided for each of the U-phase, V-phase, and W-phase, so that there are twelve coil conducting wire extended end portions 20, or ends of the respective partial coils. The coil conducting wire extended end portions 20 for each phrase and on the neutral point side are electrically connected to each other Further, a power line 22 for supplying three phase AC power is connected to one coil conducting wire extended end portion 20 for each of the U-phase, V-phase, and W-phase. The power line 22 additionally has a function of sending power, generated by a rotary electric machine, to outside.

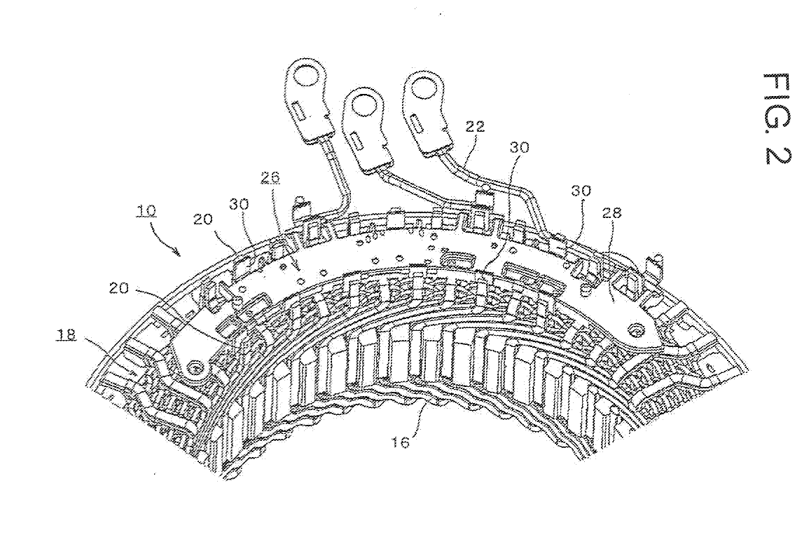

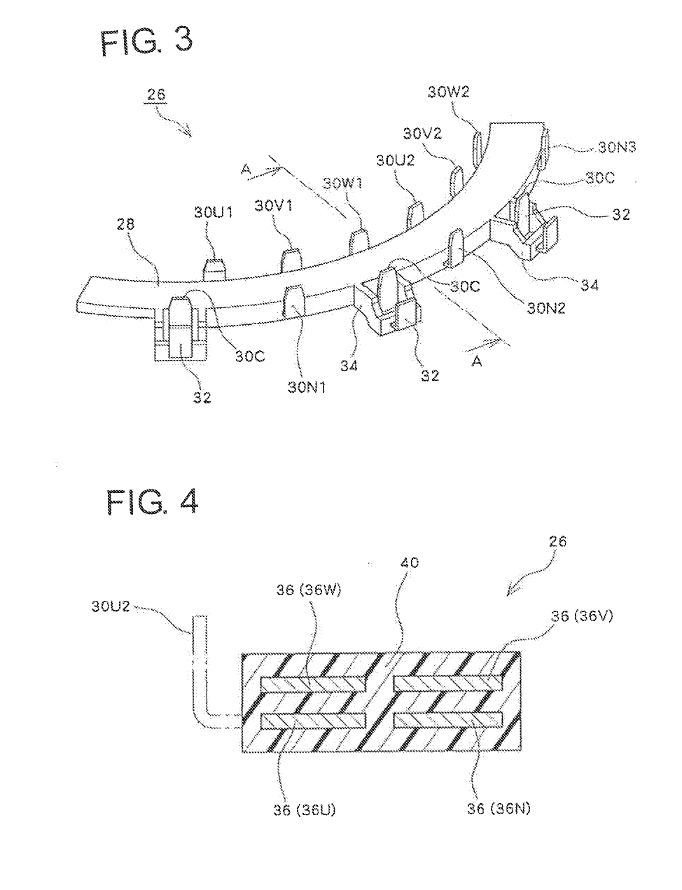

FIGS. 2 and. 3 show a bus bar module 26 that integrates a plurality of bus bars made of conductive material for connecting the coil conducting wires 16 for the respective phases to one another. FIG. 2 shows the bus bar module 26 mounted on the stator 10; FIG. 3 schematically shows the bus bar module 26 alone.

The bus bar module 26 is placed on the stator 10, in particular, adjacent to the stator coil 18, in the rotation axial direction. The bus bar module 26 has a bus bar module main body 28 that extends into an arc shape along the annular shape of the stator 10 and a terminal 30 projecting from the main body 28 and connected to the coil conducting wire extended end portion 20. A plurality of bus bars are disposed in the bus bar main body 28, extending along the arc shape of the main body 26, and an end portion of the bus bar is projecting from the bus bar main body 28, constituting the terminal 30. The terminal 30 will be hereinafter referred to as a bus bar extended end portion 30. The bus bar extended end portion 30 is projecting from the lateral surface of the bus bar main body 28, that is, a surface spreading in a direction intersecting the longitudinal direction of the has bar module main body 28. In the case of the stator 10 in this embodiment, the bus bar extended end portion 30 is projecting from each of the opposed surfaces, in particular, a lateral surface on the outer circumferential side of the arc shape of the bus bar module main body 28 and that on the inner circumferential side of the same.

Further, a holding portion 34 for holding a connection piece 32 that is connected to the power line 22 by means of welding or the like is formed projecting from the bus bar module main body 28 (see FIG. 3). Specifically, the number of the connection piece 32 provided is the same as the number of the phases. The dimension of the bus bar module main body 28 in the diameter direction, that is, the width, is equal to or smaller than the width of the stator coil 18 in the diameter direction, and the width of the entire bus has module 2 including the holding portion 34 is within in the width of the stator core 12.

The stator coil 18 is formed by connecting two partial coils for every phase to each other with a bus bar. That is, one ends of respective coil conducting wires of two partial coils are connected to a bus bar; the other end of the coil conducting wire of one partial coil is connected to a neutral point; and the other end of the coil conducting wire of the other partial coil is connected to the power line.

Referring to FIG. 3, a connection relationship between a bus bar and a coil conducting wire will be more specifically described. A bus bar extended end portion 30 connected to a U-phase coil conducting wire is indicated by numeral references 30U1, 30U2; a bus bar extended end portion 30 connected to a V-phase coil conducting wire is indicated by numeral references by 30V1, 30V2; a bus bar extended end portion 30 connected to a W-phase coil conducting wire is indicated by numeral references by 30W1, 30W2; and a bus bar extended end portion 30 connected to an end of a coil conducting wire for each phase on the neutral point side is indicated by numeral references 30N1, 30N2, 30N3. For one of the two U-phase partial coils, one end of the coil conducting wire of the partial coil is connected to the bus bar extended end portion 30U1, and the other end to the bus bar extended end portion 30N1 on the neutral point side. Meanwhile, one end of the coil conducting wire of the other partial coil is connected to the bus bar extended end portion 30U2, and, the other end to the connection piece 32. This is similarly applied to the V-phase and U-phase.

On the outer circumferential side of the bus bar module, the holding portion 34 for holding the connection piece 32 is formed. One end of the coil conducting wire 16 is connected to the connection piece 32. The connection piece 32 has, for example, a substantially J shape, and is held such that the shorter side of the J shape is located more outward in the circumferential direction. The power line 22 is connected to the shorter side, while the other end of the coil conducting wire 16 for each phase is connected to the longer side.

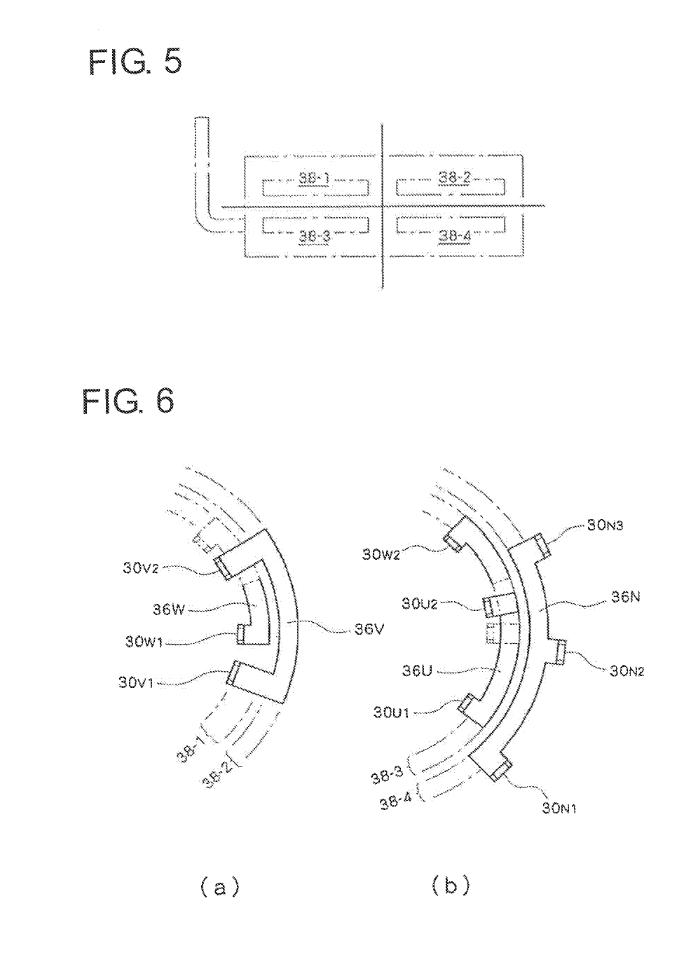

FIG. 4 is a cross sectional view of the bus bar module 26 in which four bus bars 36 respectively corresponding to the U, V, W phases and the neutral point are arranged in parallel, that is, a cross sectional view along, e.g. the line A-A in FIG. 3. The bus bar 36 has a flat plate shape that is elongated for connection between predetermined coil conducting wires. Four bus bars 36 are disposed 2×2, that is, two layers in the up-down direction and two lines in the left-right directions. Note that in this specification, the rotation axial direction of a rotary electric machine is defined as the up-down direction, and the side closer to the stator is defined as a lower side, while that farther from the stator as an upper side. Further note that, in the description, a direction perpendicular to the rotation axial direction, that is, the diameter direction of a rotary electric machine, is defined as the left-right direction, and the inner side of the rotary electric machine is defined as the left side, while the outer side is defined as the right side. These directions described above are determined here only for convenience in description, and have nothing to do with the directions and orientations in actual disposition of the machine. Further, when the four bus bars 36 need to be discriminated from one another, bus bars for the respective U, V, and W-phases (phase coil bus bar) are indicated by numeric references 36U, 36V, and 36W, respectively, and a bus for a neutral point (a neutral point bus bar) is indicated by 36N in the following description. As shown, the U-phase bus bar 36U is disposed in the lower layer in the left line; the V-phase bus bar 36V is disposed in the upper layer in the right line; the W-phase bus bar 36W is disposed in the upper layer in the left line; and the neutral point phase bus bar 36N is disposed in the lower layer in the right line. Each of the four areas in the 2×2 disposition is referred to as a section 38. As shown in FIG. 5, of the four segments, one in the upper layer in the left line is referred to as a section 38-1, one in the upper layer in the right line as a section 38-2, one in the lower layer in the left line as a section 38-3, and one in the lower layer in the left line as a section 38-4.

The bus bar module 26 has an insulating member 40 for insulating the bus bars 36 from one another and covering the bus bars 36 to thereby insulate the bus bars 36 from outside. The insulating member 10 is molded using, for example, resin, and integrated with the bus bars 36U, 36V, 36W, 36N through molding. Note that although the insulating member 40 is shown integrated in the diagram, the insulating member 40 may be divided into two or more pieces, depending on a molding condition. For example, the cross-shaped section in the insulating member 40 may be molded first, followed by disposition of a bus bar on the cross-shaped section, and the rectangular outer section is then molded using resin so as to include all these. The material of the insulating member 40 may be general plastic. Besides, engineering plastic or super engineering plastic may be employed, depending on a condition of use or the like.

FIG. 6 shows the individual shapes of the bus bars 36U, 36V, 36W, and 36N. The diagram (a) in FIG. 6 shows an upper layer, that is, layer to which the segments 38-1,38-2 belong; and the diagram (b) in FIG. 6 shows a lower layer, that is, a layer to which the segments 38-3, 38-4 belong. The respective bus bars 36U, 36V, 36W, 36N are made by elongating a flat plate member into, in particular, a substantially arc shape, in which the plate surfaces of the respective bus bars 36U, 36V, 36W, 36N are positioned on the flat surface defined by the arc shape. A bus bar extended end portion 30 is formed at both respective ends of the arc shape or at both respective ends and a middle position of the arc shape. The bus bar extended end portion 30 is tapered, as will be described later, and the bus bars 36U, 37V, and 36W for the respective U, V, and W-phases are a both-tapered-end bus bar, or a bus bar having tapered shapes formed on both respective ends thereof. The bus bar 36N at a neutral point is also a both-tapered-end bus bar, or a bus bar having a tapered shape at both respective ends thereof, which additionally has a branched portion formed between both respective ends thereof, where a tapered bus bar extended end portion 30 is formed,

The U-phase bus bar 36U is positioned in the section 38-3 in the lower layer on the left side. The V-phase bus bar 36V is positioned in the upper layer, and extends from the terminal 30V1 across the section 38-1 on the left side, then along the section 38-2 on the right side, and again across the section 38-1 on the left side to reach the terminal 30V2. The W-phase bus bar 36W extends from the terminal 30W1 along the section 38-1, then shifts from the upper layer to the lower layer at a position past the terminal 30U2, and extends along the section 38-3 to the terminal 30W2. The neutral point bus bar 36 extends along the section 38-4 in the lower layer on the right side. As described above, in the bus bar module main body 28, the four bus bars 36 are arranged two in the respective upper and lower layers and two side by side on the respective left and right sides.

The connection piece 32 for connecting the coil conducting wire 16 and the power line 22 can be considered as a bus bar that is made using a flat plate conductor. In the description below, the connection piece 32 is referred to as a power line bus bar 32. One end of the power line bus bar 32 is a bus bar extended end portion to be welded to the coil conducting wire 16, being indicated by 30C in FIG. 3.

In a description on the shape of the bus bars 32, 36, the direction in which the bus bar extends is defined as a longitudinal direction. A direction intersecting the longitudinal direction and extending along the flat plate surface is defined as a width direction, and a dimension in that direction is defined as a width. Further, a direction intersecting the longitudinal direction and penetrating the plate surface is defined as a thickness direction, and a dimension in that direction is defined as a thickness.

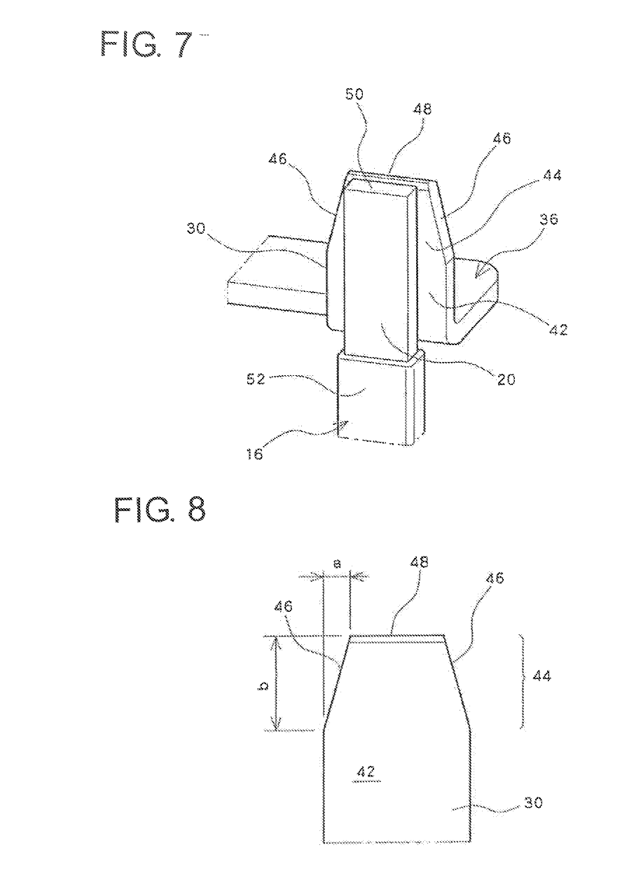

FIG. 7 shows a detailed shape of the bus bar extended end portion 30 and the coil conducting wire extended end portion 20. FIG. 8 shows a detailed shape of the bus bar extended end portion 30. Regarding the bus bar extended end portion 30, the longitudinal direction corresponds to the up-down direction in FIGS. 7 and 8, the left-right direction corresponds to the width direction, and the depth direction corresponds to the thickness direction As shown, the bus bar extended end portion 30 and the coil conducting wire extended end portion 20 extend in parallel in the same direction such that the tip ends thereof are directed upward, that is, in a direction departing from the stator coil 18. The coil conducting wire extended end portion 20 is placed adjacent to the wider lateral surface 42 of the bus bar 36. The coil conducting wire 16 is a so-called flat wire having a rectangular cross section, and positioned such that the longer side of the rectangle is opposed to the wider lateral surface 42 of the bus bar 36.

The width of the bus bar 36 is larger than that of the coil conducting wire 16. A tapered portion 44 that becomes narrower in the width direction as it goes towards the tip end is formed on the tip end of the bus bar extended end portion 30. The slant surfaces 46 constituting the tapered shape are formed, preferably, symmetrical to each other on both respective sides. The dimension of the tapered shape is such that the dimension b in the longitudinal direction is longer than the dimension a in the width direction shown in FIG. 8. The dimension b in the longitudinal direction is longer than the length of beveling for removing en edge or burr of a member. For a bus bar having a width of a few millimeters, the dimension of normal beveling for edge removal is smaller than one millimeter. Thus, in the bus bar having the above described dimension, the dimension b in the longitudinal direction of the tapered shape is equal to or larger than 1 mm.

The coil conducting wire 16 has a constant cross segmental shape, and at the coil conducting wire extended end portion 20 the conductor is exposed with the coat 52 removed. The width of the tip end surface 48 of the bus bar 36, that is, the width of the tip end of the tapered portion 44, remains larger than that of the tip end surface 50 of the coil conducting wire 16 despite the presence of the tapered shape. The position of the coil conducting wire 16 extending from the coil end portion of the stator coil 18 cannot be determined with high accuracy in a manufacturing process, and each one is therefore positioned slightly different from the intended position. In order to tolerate the difference, the tip end surface 48 of the bus bar has a wider width than the tip end surface 50 of a coil conducting wire.

FIG. 7 shows as an example a bus bar extended end portion 30 formed on both respective and portions of the phase bus bar 36U, 36V, 36W, and the neutral point, bus bar 36N. Note that the bus bar extended end portion 30N2 formed at a middle position of the neutral point bus bar 36N also has a similar tapered shape (see FIG. 3) Further, the bus bar extended end portions 30C of the three power line bus bars 32 also have a similar tapered shape (see. FIG. 3). Note that in FIG. 2, the tapered shape of the bus bar extended end portion 30 is not shown.

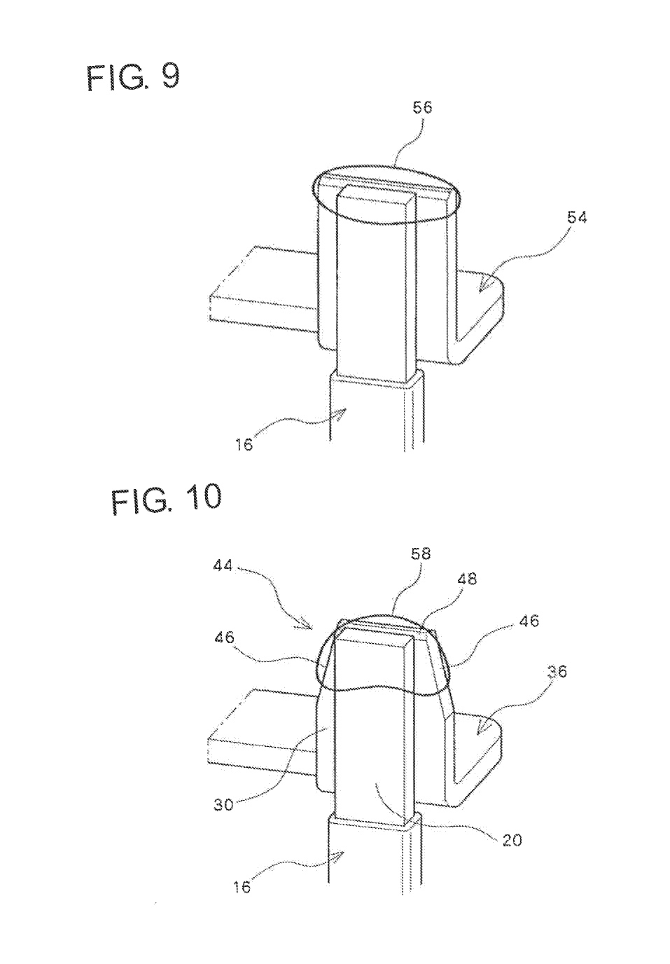

FIGS. 9 and 10 show welding parts having different shapes attributable to presence or absence of the tapered portion 44. FIG. 9 relates to a case in which the bus bar 54 without the tapered portion 44 is used, while FIG. 10 relates to a case in which the bus bar 36 having the tapered portion 44 is used. In welding, an end portion of the coil conducting wire 16 and that of the bus bar 54 are heated from thereabove, with the end portions to be welded both placed directed upward. As the width of the top surface of the bus bar 54 having no tapered portion is wider, welded material remains on the top surface of the bus bar 54 due to surface tension, and a welding ball 56 resulting from consolidation of the welded material is formed only in an area very near the tip end surface of the bus bar 54 and the coil conducting wire 16.

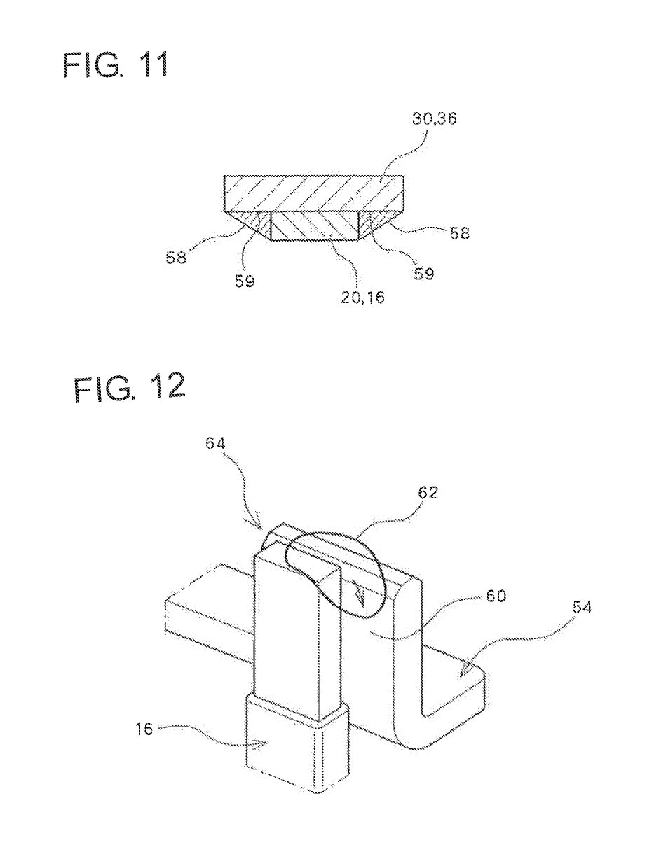

Meanwhile, when the bus bar 35 having the tapered portion 44, shown in FIG. 10, is used as the tip end surface 48 of the bus bar is narrow, welding heat is transmitted to a deeper position, that is, a position sway from the tip end surface 48 of the bus bar in the longitudinal direction of the bus bar, so that a deeper area in the bus bar 36 is also welded. In addition, the welded material, flows downward along the slant surface 46 of the tapered portion 44, so that a welding ball 58 is formed covering a deeper position. Moreover, the welding ball 58 made of the material having flowed downward is formed in a stepped part that is formed due to difference in the width between the coil conducting wire extended end portion 20 and the bus bar extended end portion 30, as shown in FIG. 11. This can reliably connect the coil conducting wire 16 and the bus bar 36. With all the described above, a welded portion can be formed covering a larger area over the coil conductive wire and the bus bar, so that the connection can be strengthened.

FIG. 12 shows an example in which the bus bar 54 without a tapered portion is welded to the coil conducting wire 16 in a displace position in the width direction. When the coil conducting wire 16 is positioned displaced, the wider lateral surface 60 of the wider lateral surface 60 is exposed one-sidedly, and the welded material flows into a side with the wider lateral surface 60 largely exposed due to surface tension. Consequently, the welding ball 62 is formed one-sided, with no welding area formed on the lateral surface 60 on the other side. Meanwhile, in a case where the tapered portion 44 is formed, as welded material flows along the slant surface 46, the possibility of one-sided formation of a welding ball, that is, a welding area, can be reduced even though the displacement results.

### DESCRIPTION OF REFERENCE NUMERALS

10 stator, 16 coil conducting wire, 20 coil conducting wire extended end portion, 22 power line, 26 bus bar module, 30 bus bar extended end portion, 32 connection piece (power line bus bar), 36 bus bar, 44 tapered portion, 46 slant surface, 48 bus bar tip end surface, 50 coil conducting wire tip end surface.

1. A stator of a rotary electric machine, comprising:
a plurality of coil conducting wires mounted on a stator core; and
at least one bus bar that is made using a flat plate member wider than the coil conducting wire, and connected to at least one of the coil conducting wires,
wherein
at least one end portion of the bus bar and at least one end portion of the coil conducting wire have a bus bar extended end portion and a coil conducting wire extended end portion, respectively, which extend in parallel,
the coil conducting wire extended end portion is placed adjacent to a wider lateral surface of the bus bar that is made using a flat plate member,
a tip end of the bus bar extended end portion is tapered in a width direction, and
tip ends of the coil conducting wire extended end portion and of the bus bar extended end portion are welded to each other.

2. The stator of a rotary electric machine according to claim 1, wherein a width of the tip end of the bus bar extended end portion is larger than a width of a tip end of the coil conducting wire.

3. The stator of a rotary electric machine according to claim 1, wherein a cross section of the coil conducting wire has a rectangular shape, and a longer side of the rectangular shape is opposed to the bus bar.

4. The stator of a rotary electric machine according to claim 3, wherein
the bus bar includes at least one phase coil bus bar for each phase for connecting the coil conducting wires for the phase of the rotary electric machine to each other to thereby form a stator coil for the phase, and
the stator further includes a bus bar module that is molded so as to integrate the phase coil bus bars, using insulating material.

5. The stator of a rotary electric machine according to claim 4, wherein
the bus bar further includes a neutral point bus bar for connecting one end of each of the stator coils for three phases to one another to thereby constitute a neutral point, and
the bus bar module includes the neutral point bus bar integrated thereto through molding.

6. The stator of a rotary electric machine according to claim 4, wherein
the bus bar further includes a power line bus bar that is connected to a coil conducting wire at one end thereof and to a power line at another end thereof, and
the bus bar module includes the power line bus bar integrated thereto through molding.

7. The stator of a rotary electric machine according to claim 4, wherein the bus bar module is placed adjacent to the stator coil in a rotation axial direction of the rotary electric machine.

8. The stator of a rotary electric machine according to claim 7, wherein the coil conducting wire extended end portion and the bus bar extended end portion extend along the rotation axial direction of the rotary electric machine in a direction departing from the stator core.

9. The stator of a rotary electric machine according to claim 1, wherein
the bus bar has the bus bar extended end portion formed at one end thereof,
a coil conducting wire is connected to the bus bar extended end portion, and
a power line is connected to another end portion thereof.

10. The stator of a rotary electric machine according to claim 2, wherein
the bus bar has the bus bar extended end portion formed at one end thereof,
a coil conducting wire is connected to the bus bar extended end portion, and
a power line is connected to another end portion thereof.

11. The stator of a rotary electric machine according to claim 3, wherein
the bus bar has the bus bar extended end portion formed at one end thereof,
a coil conducting wire is connected to the bus bar extended end portion, and
a power line is connected to another end portion thereof.

12. The stator of a rotary electric machine according to claim 5, wherein
the bus bar further includes a power line bus bar that is connected to a coil conducting wire at one end thereof and to a power line at another end thereof, and
the bus bar module includes the power line bus bar integrated thereto through molding.
